(19) United States
(12) Patent Application Publication
(10) Pub. No.: US 2018/0022260 A1
(43) Pub. Date: Jan. 25, 2018

(54) MOBILE SHOWROOM

(71) Applicant: PRMB DESIGN LLC, Warren, MI (US)

(72) Inventors: Mohamad Achmar, Plano, TX (US); Behrooz Rostam, Troy, MI (US)

(21) Appl. No.: 15/657,402

(22) Filed: Jul. 24, 2017

Related U.S. Application Data
(60) Provisional application No. 62/365,701, filed on Jul. 22, 2016.

(51) Int. Cl. B60P 3/025; G09F 21/04; G09F 5/00

(52) U.S. Cl. CPC B60P 3/0255; G09F 5/00; G09F 21/04

(57) ABSTRACT

A mobile showroom may have multiple flexible wall mount panels to conform to a vehicle interior, wherein the panels having at least one lateral rib, multiple threaded mounting inserts and multiple panel mounting holes affixable to the vehicle interior, at least one top bracket adjustably coupled to at least one threaded mounting insert, wherein the top bracket has a top bracket retention lip, at least one bottom bracket adjustably coupled to another threaded mounting insert, wherein the bottom bracket has a bottom bracket retention lip and the bottom is in vertical alignment with the top bracket to hold a sample securely and at least one bracket support bar to rotatably link the at least one bottom bracket to another bottom bracket.

### CROSS-REFERENCE TO RELATED APPLICATION

This application claims priority to provisional patent application No. 62/365,701 filed on Jul. 22, 2016 and entitled “MOBILE SHOWROOM”, the entire contents of which are hereby incorporated by reference.

### TECHNICAL FIELD OF THE APPLICATION

This application relates to mobile showrooms and more specifically to a wall mount configuration that can be affixed to the interior wall of a van or truck to provide a mount for samples of various products such as flooring.

### BACKGROUND OF THE APPLICATION

Conventionally, when a merchant desires to share carpet, flooring and other types of samples for sale to potential buyers, the merchant must rent a space for potential customers to visit and make their selections. The amount of space required to share the samples may be negligible. The organization and layout of the samples is an aspect that does not require an entire office facility or showroom to house.

### SUMMARY OF THE APPLICATION

One example embodiment of the present application may provide at least one of a plurality of flexible wall mount panels to conform to a vehicle interior, wherein the panels having at least one lateral rib, a plurality of threaded mounting inserts and a plurality of panel mounting holes affixable to the vehicle interior, at least one top bracket adjustably coupled to at least one threaded mounting insert, wherein the top bracket has a top bracket retention lip and wherein the at least one top bracket adjustable coupling provides a spring force to the at least one top bracket, at least one bottom bracket adjustably coupled to another threaded mounting insert, wherein the bottom bracket has a bottom bracket retention lip and the bottom is in vertical alignment with the top bracket and wherein the at least one bottom bracket adjustable coupling provides a spring force to the at least one bottom bracket and holds a sample securely and at least one bracket support bar to rotatably link the at least one bottom bracket to another bottom bracket.

Another example embodiment of the present application may provide at least one of at least four flexible wall mount panels to conform to a vehicle interior, three of the panels vertically connected to one another and one panel laterally connected to one of the three vertically connected panels, wherein the panels having at least one lateral rib, a plurality of threaded mounting inserts and a plurality of panel mounting holes affixable to the vehicle interior, at least one top bracket adjustably coupled to at least one panel via at least one of the plurality of threaded mounting inserts, wherein the top bracket has a top bracket retention lip and wherein the at least one top bracket adjustable coupling provides a spring force to the at least one top bracket, at least one bottom bracket adjustably coupled to the at least one panel via at least another one of the plurality of threaded mounting inserts, wherein the bottom bracket has a bottom bracket retention lip and the bottom is in vertical alignment with the top bracket and wherein the at least one bottom bracket adjustable coupling provides a spring force to the at least one bottom bracket and holds a sample securely and at least one bracket support bar to rotatably link the at least one bottom bracket to another bottom bracket.

Yet another example embodiment of the present application may provide at least one of device having at least at least one frame mountable to a vehicle interior, at least one top shelf having angled tracks, the at least one shelf rotatably coupled to the at least one frame, at least one retention spring coupling the at least one top shelf to the at least one frame to bias the at least one top shelf and at least one bottom shelf opposite the at least one top shelf, the at least one bottom shelf coupled to the the at least one frame.

### BRIEF DESCRIPTION OF THE DRAWINGS

FIG. 1 illustrates a wall mount configuration according to example embodiments.

FIG. 2 illustrates brackets for the wall mount configuration according to example embodiments.

FIG. 3 illustrates the brackets affixed to the wall mount configuration according to example embodiments.

FIG. 4 illustrates the brackets affixed to the wall mount with a bracket support bar according to example embodiments.

FIG. 5 illustrates a complete wall and flooring showroom configuration for the driver side of a vehicle according to example embodiments.

FIG. 6 illustrates a complete wall and flooring showroom configuration for the passenger side of a vehicle according to example embodiments.

FIG. 7 illustrates a compression shelving system according to example embodiments.

FIG. 8 illustrates an expanded compression shelving system according to example embodiments.

FIG. 9 illustrates an alternate compression spring for the compression shelving system according to example embodiments.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

Example embodiments provide a device for mounting to a wall of an interior of a vehicle (i.e., van, truck, motor home, trailer, etc.). The wall mount configuration includes lips and grooves for receiving upper and lower mounting brackets which may be fitted to size to accommodate product samples such as flooring samples. The device allows for a flooring sample shop at home experience where customers get to view and interact with various samples provided by the user.

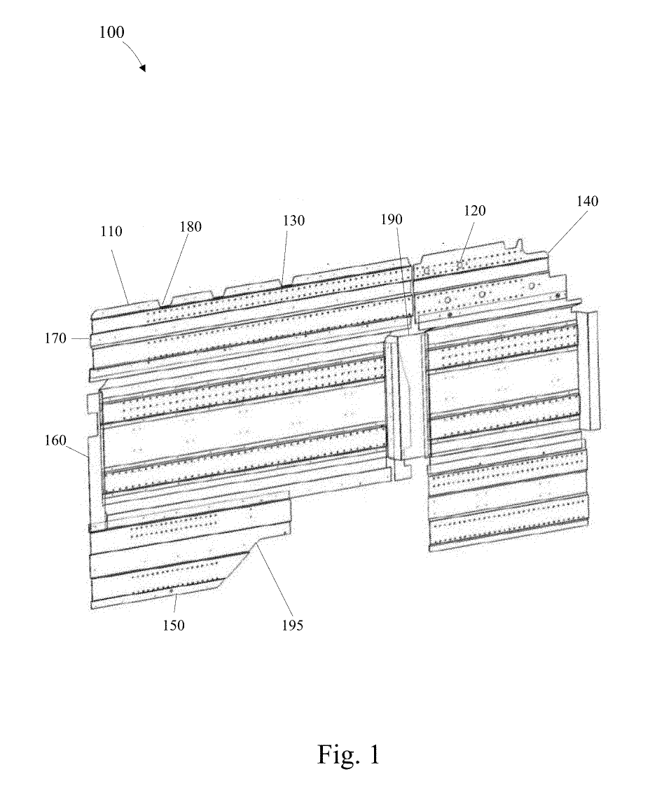

FIG. 1 illustrates a wall mount configuration according to example embodiments. Referring to FIG. 1, the configuration 100 includes four main pieces which together form a wall mount configuration. The panels themselves may be connected to one another by way of interlocking flanges, rivets, screws and the like.

The custom fitted wall mounted panels are designed to be flexible to match the contour of the vehicle and maximize product sample volume. The panels comprise a top panel 110, middle panel 160 and bottom panel 150 along with a lateral panel 140. The panels have panel mounting holes 120 to affix panels to existing mounting locations of the vehicle. Mounting threaded inserts 130 are used to adjust brackets, and rivet locations are shown throughout the right sheet as well. Although mounting threaded inserts are shown in the present example, the fixing of the brackets to the panels may also be done through the use of machine screws into appropriately sized mounting holes in the panels. Additionally, the brackets may be fixed to the panels by rivets, slots and the like. The panels may be constructed of plastic, sheet metal, engineered wood or a lay-up of multiple materials to achieve the sound and temperature insulation properties sought by the user.

The panels have lateral ribs 170 which strengthen the panel in a length direction while allowing flexibility in the height direction. The panels also have notches 180 which allow the panel to for clearance around a vehicle support rib and to comport to the interior of the vehicle as well as channels 190 for clearance around the vehicle support rib. There is also a wheel well cutout 195 for clearance around a wheel well to accommodate the wheel well.

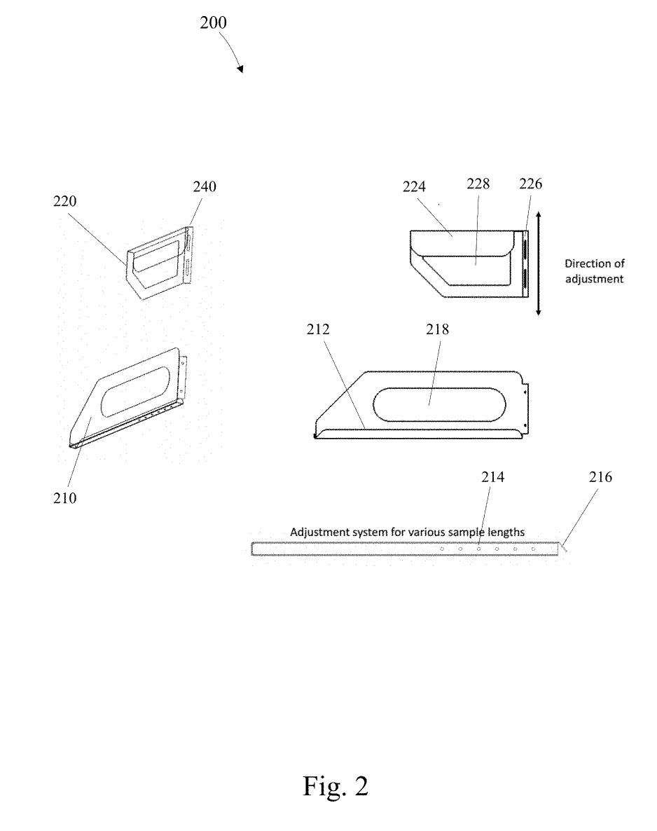

FIG. 2 illustrates brackets for the wall mount configuration according to example embodiments. Referring to FIG. 2, the brackets 200 include the top bracket 220 which includes a lip to secure the sample and long securing holes to permit adjustment in the size of the sample. The side view of the top bracket illustrates the lip and connection slots 226 which form elongated securing holes. The bottom bracket 210 includes a bottom bracket retention lip 212 and bottom bracket length adjustment holes 214 for various sized sample products. The side view also illustrates a bottom lip for securing the sample. The device allows each sample to held separately from the other samples and to be held between the top bracket and the bottom bracket.

The top bracket has a top bracket retention lip 224 which allows the retention and sliding of the sample out of the bracket. The top bracket also has connection slots 226 that allow the fixing of the top bracket to the threaded mounting inserts with flexibility in height. The top bracket attachment portion 240 that mounts the top bracket to the panel also provides a spring like action to the top bracket. Additionally, the top bracket has a top bracket window 228 which allows viewing of the sample while still retrained.

The bottom bracket has a bottom bracket retention lip 212 which allows sliding of the sample out of the bracket in the same manner as the top bracket. The top and bottom bracket being offset in height and working together to hold the sample in place. The bottom bracket has bottom bracket length adjustment holes 214 which allow various lengths of samples to be held along the bottom side edge of the sample. The bottom bracket attachment portion 216 which mounts the bottom bracket to the panel providing a spring like action to the bottom bracket. The bottom bracket also has a bottom bracket window 218 which allows samples to be viewed in place.

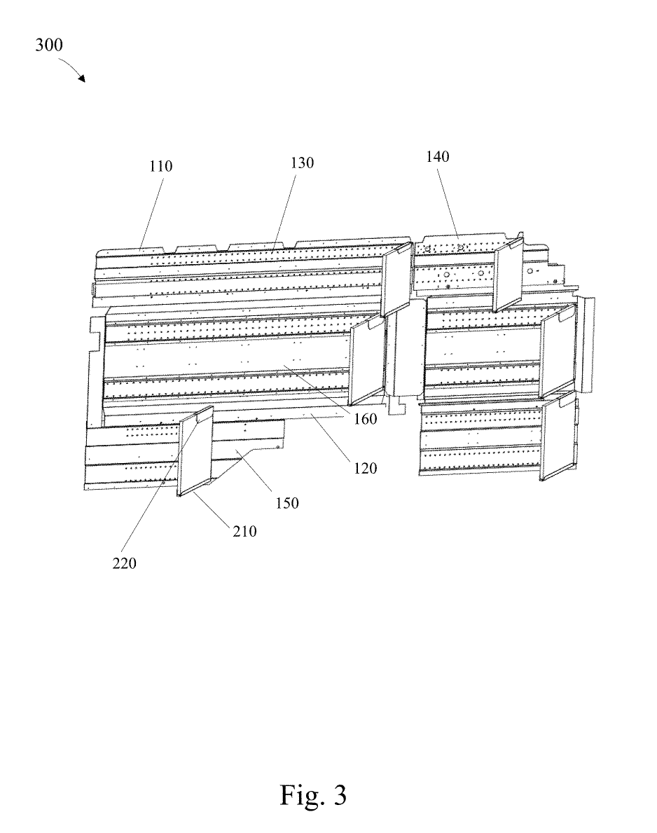

FIG. 3 illustrates the brackets affixed to the wall mount configuration 300 according to example embodiments. Referring to FIG. 3, the same numerals refer to like elements in other drawings. In this example, the top brackets 220 and bottom brackets 210 which are secured by the threaded mounting inserts are shown securing samples in six places throughout the wall mount configuration. Multiple brackets and samples may be affixed through the wall mount configuration depending on the desired configuration. In this example, the top panel 110, middle panel 160 and bottom panel 150 along with the lateral panel 140 are shown. The panels are secured to the vehicle interior by means of connectors through the panel mounting holes 120.

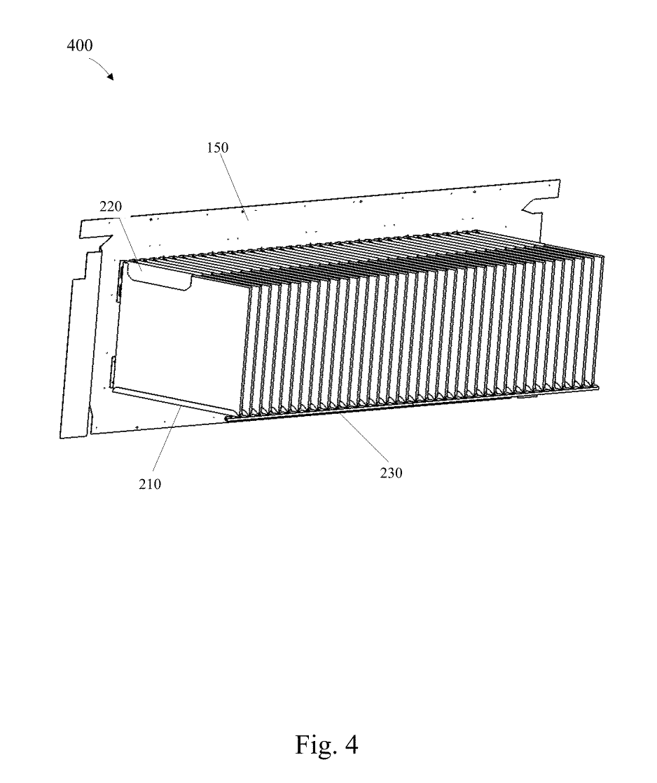

FIG. 4 illustrates the brackets affixed to the wall mount 400 with a bracket support bar according to example embodiments. Referring to FIG. 4, the example 400 includes a bottom panel 150 with a set of multiple brackets including the top brackets 220 and bottom brackets 210. The brackets are aligned by a removable bracket support bar 230 to prevent undesired movement of the samples.

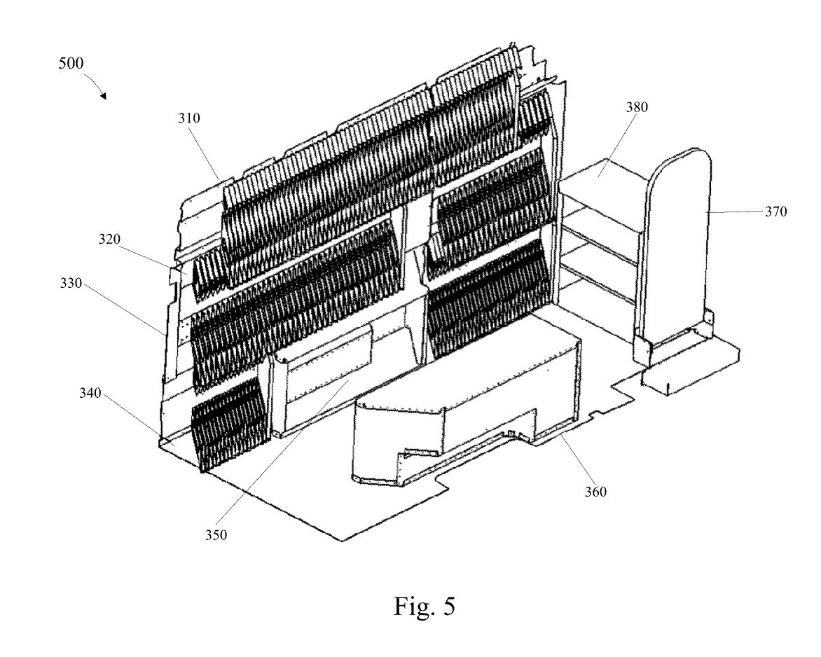

FIG. 5 illustrates a complete wall and flooring showroom configuration for the driver side of a vehicle according to example embodiments. Referring to FIG. 5, the large-scale view 500 includes a mounting substructure 310, a module bracket shelf system 320, an insulating sound proofing configuration 330, a flush flooring configuration 340, a driver's side fixed cabinet assembly 350, a passenger side fixed cabinet assembly 360, a front fixed sample cabinet 370, and a display table 380 that may be pivoted and one of folded down or slid out to a table with the side door of the vehicle open. The driver's side fixed cabinet assembly 350, the passenger side fixed cabinet assembly 360 and the front fixed sample cabinet 370 allow for additional materials to be stored within the vehicle in an orderly fashion. The display table 380 allows for the various samples to be looked at by a customer side by side to allow the customer a more showroom like experience in the vehicle. The compact nature of the wall and flooring showroom configuration allows a wide variety of samples to be reviewed by the customer in a compact area. This efficient use of space allows a reduction in cost as a rented showroom is no longer necessary for the customer to view the requisite samples.

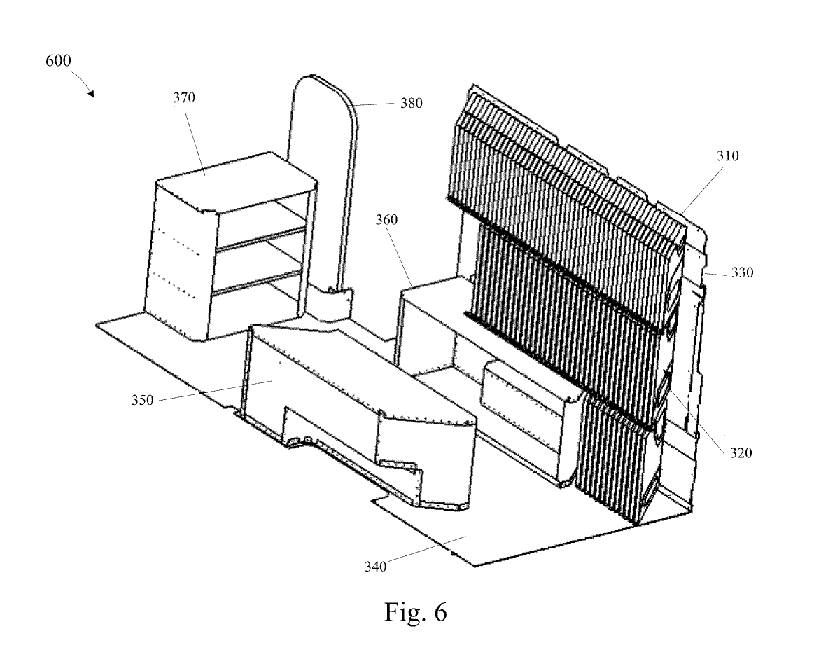

FIG. 6 illustrates a complete wall and flooring showroom configuration 600 for the passenger side of a vehicle according to example embodiments. Referring to FIG. 6, the like numerals refer to like components. The passenger side may house fewer samples than the driver side of the vehicle depending on the configuration. The variation in configurations allows tailoring of the vehicle showroom to the representatives offerings.

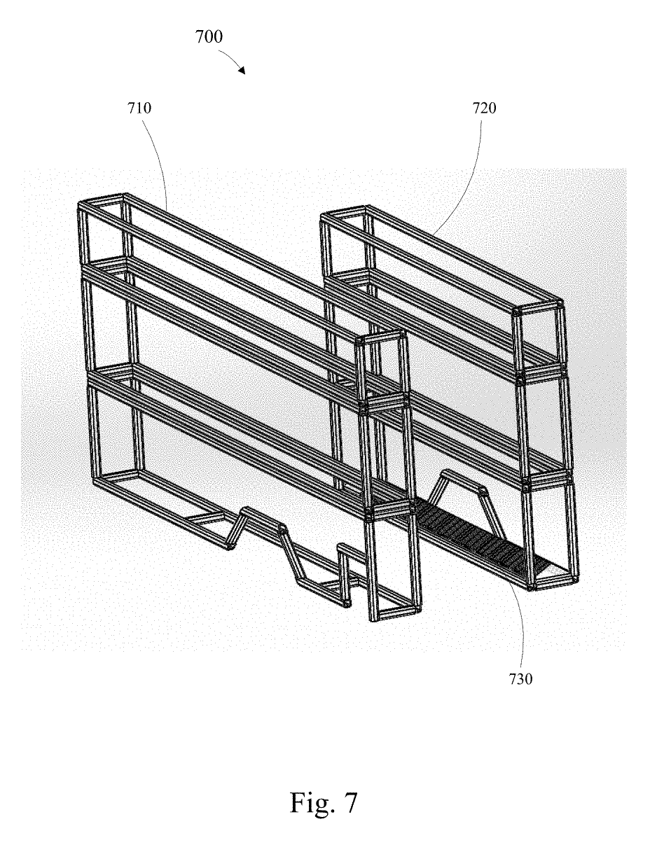

FIG. 7 illustrates a frame 710, 720 for a set of compression shelves 700. The shelves will fit within the frame, a lower shelf 730 is shown. In this example the lower shelf is comprised of high density polyethylene having angled tracks to retain the samples.

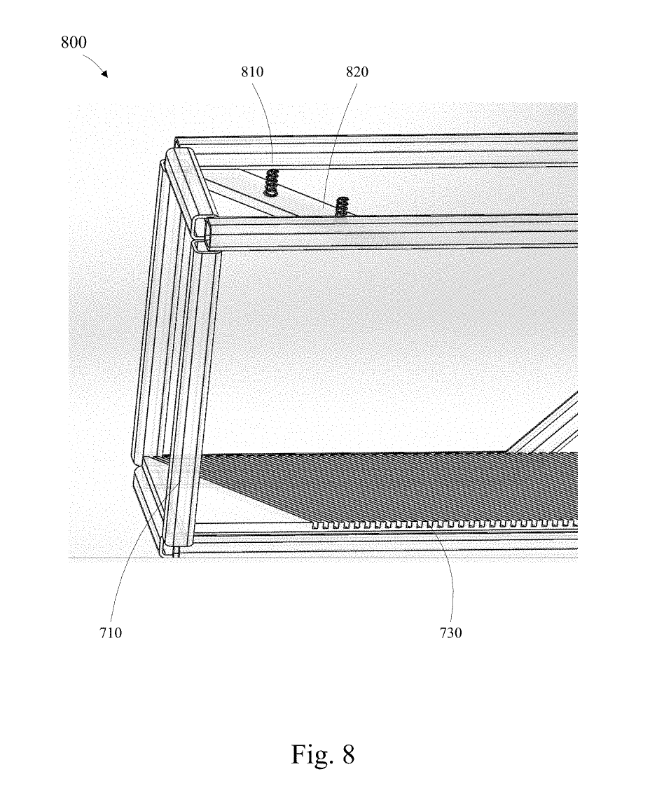

FIG. 8 depicts a frame 710, a lower shelf 730 and an upper shelf 820 biased toward the lower shelf by a coil spring 810. In this example 800 the lower shelf is comprised of high density polyethylene having angled tracks to retain the samples.

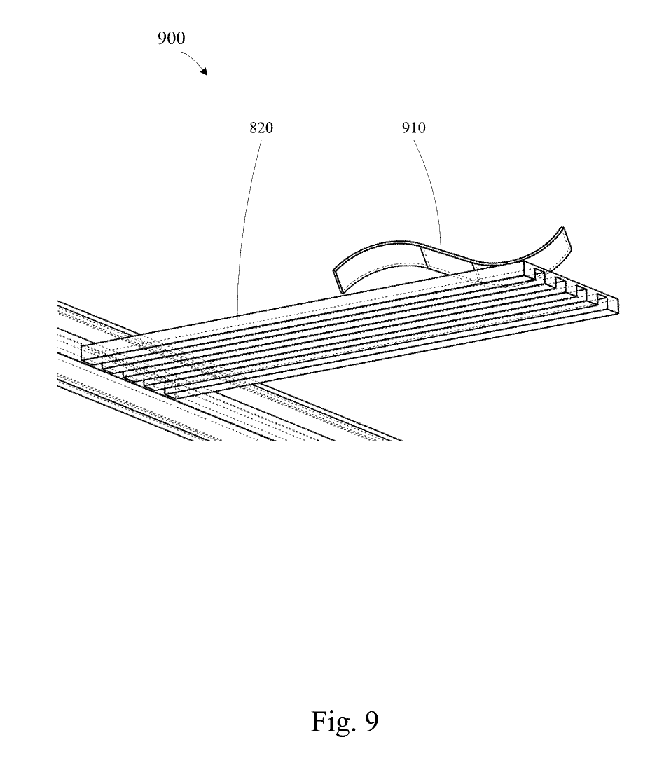

FIG. 9 depicts an alternate biasing method using a flat spring 910 to bias upper shelf 820 toward the lower shelf. In this example 900 the upper shelf is comprised of high density polyethylene having angled tracks.

It will be readily understood that the components of the disclosure, as generally described and illustrated in the figures herein, may be arranged and designed in a wide variety of different configurations. Thus, the detailed description of the embodiments is not intended to limit the scope of the invention as claimed, but is merely representative of selected embodiments.

One having ordinary skill in the art will readily understand that the disclosure as discussed above may be practiced with steps in a different order, and/or with hardware elements in configurations that are different than those which are disclosed. Therefore, although the disclosure has been described based upon these preferred embodiments, it would be apparent to those of skill in the art that certain modifications, variations, and alternative constructions would be apparent, while remaining within the spirit and scope of the disclosure. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications thereto.

What is claimed is:

1. A device, comprising:
a plurality of flexible wall mount panels to conform to a vehicle interior,
wherein the panels having at least one lateral rib, a plurality of threaded mounting inserts and a plurality of panel mounting holes affixable to the vehicle interior;
at least one top bracket adjustably coupled to at least one threaded mounting insert, wherein the top bracket has a top bracket retention lip and wherein the at least one top bracket adjustable coupling provides a top spring force to the at least one top bracket;
at least one bottom bracket adjustably coupled to another threaded mounting insert, wherein the bottom bracket has a bottom bracket retention lip and the bottom is in vertical alignment with the top bracket and wherein the at least one bottom bracket adjustable coupling provides a bottom spring force to the at least one bottom bracket and holds a sample securely; and
at least one bracket support bar to rotatably link the at least one bottom bracket to another bottom bracket.

2. The device of claim 1 wherein, at least one panel having at least one top notch for clearance around a vehicle support rib.

3. The device of claim 1 wherein, at least one panel having at least one channel for clearance around a vehicle support strut.

4. The device of claim 1 wherein, at least one panel having at least one wheel well cutout for clearance around a vehicle wheel well.

5. The device of claim 1 wherein, the at least one bottom bracket having a window.

6. The device of claim 1 wherein, the at least one top bracket having a window.

7. The device of claim 1 wherein, the at least one bottom bracket having a plurality of length adjustment holes.

8. The device of claim 1 wherein, the at least one top bracket having a plurality of connection slots allowing vertical height adjustment.

9. The device of claim 1 further comprising a cabinet connectable at least one panel.

10. The device of claim 1 further comprising a display table connectable at least one panel, wherein the display table may be one of folded out and slid out.

11. A device, comprising:
at least four flexible wall mount panels to conform to a vehicle interior, three of the panels vertically connected to one another and one panel laterally connected to one of the three vertically connected panels,
wherein the panels having at least one lateral rib, a plurality of threaded mounting inserts and a plurality of panel mounting holes affixable to the vehicle interior;
at least one top bracket adjustably coupled to at least one panel via at least one of the plurality of threaded mounting inserts, wherein the top bracket has a top bracket retention lip and wherein the at least one top bracket adjustable coupling provides a top spring force to the at least one top bracket;
at least one bottom bracket adjustably coupled to the at least one panel via at least another one of the plurality of threaded mounting inserts, wherein the bottom bracket has a bottom bracket retention lip and the bottom is in vertical alignment with the top bracket and wherein the at least one bottom bracket adjustable coupling provides a bottom spring force to the at least one bottom bracket and holds a sample securely; and
at least one bracket support bar to rotatably link the at least one bottom bracket to another bottom bracket.

12. The device of claim 11 wherein, at least one panel having at least one top notch for clearance around a vehicle support rib.

13. The device of claim 11 wherein, at least one panel having at least one channel for clearance around a vehicle support strut.

14. The device of claim 11 wherein, at least one panel having at least one wheel well cutout for clearance around a vehicle wheel well.

15. The device of claim 11 wherein, the at least one bottom bracket having a window in a side of the bracket and the at least one top bracket having a window in a side of the bracket.

16. The device of claim 11 wherein, the at least one bottom bracket having a plurality of length adjustment holes.

17. The device of claim 11 wherein, the at least one top bracket having a plurality of connection slots allowing vertical height adjustment.

18. The device of claim 11 further comprising a cabinet connectable at least one panel.

19. The device of claim 11 further comprising a display table connectable at least one panel, wherein the display table may be one of folded out and slid out.

20. A device, comprising:
at least at least one frame mountable to a vehicle interior;
at least one top shelf having angled tracks, the at least one shelf rotatably coupled to the at least one frame;
at least one retention spring coupling the at least one top shelf to the at least one frame to bias the at least one top shelf; and
at least one bottom shelf opposite the at least one top shelf, the at least one bottom shelf coupled to the at least one frame.
